(19) United States
(12) Patent Application Publication
(10) Pub. No.: US 2026/0284548 A1
(43) Pub. Date: Sep. 24, 2026

(54) DISTILLATION SYSTEM FLUID LEVEL CONTROL SYSTEM

(71) Applicant: HONEYWELL INTERNATIONAL INC., Charlotte, NC (US)

(72) Inventors: Matthew Dunn, Phoenix, AZ (US); Kevin Dittmar, Phoenix, AZ (US); Jeffrey Maldonado, Phoenix, AZ (US)

(73) Assignee: HONEYWELL INTERNATIONAL INC., Charlotte, NC (US)

(21) Appl. No.: 19/083,820

(22) Filed: Mar. 19, 2025

(51) Int. Cl. B01D 1/00; B01D 1/14; B01D 3/02; B01D 3/42

(52) U.S. Cl. CPC B01D 1/0076; B01D 1/0058; B01D 1/0082; B01D 1/14; B01D 3/02; B01D 3/42; C02F 1/16

(57) ABSTRACT

A distillation system fluid level control system includes a tank, a diffuser, a fluid pump, a fluid level sensor, and a level control. The tank has an inner volume and a divider wall divides the inner volume into a main chamber and a settling chamber. The main chamber has at least a fluid inlet port and an exhaust gas inlet port, and the settling chamber has at least an exhaust gas outlet port. The diffuser is disposed within the main chamber and is adapted to receive exhaust gas discharged from a gas turbine engine. The fluid pump supplies fluid to the tank. The fluid level sensor senses fluid level within the settling chamber and supply a fluid level sensor signal representative thereof. The level control supplies pump commands to the fluid pump based on the fluid level sensor signal, to control the fluid level in the tank.

### TECHNICAL FIELD

The present disclosure generally relates to distillation systems, and more particularly to a distillation system fluid level control system.

### BACKGROUND

Various industrial processes, including hydraulic fracturing (i.e., fracking), produce wastewater. The wastewater that is produced may include dissolved salts, metals, and other contaminants. Preferably, this wastewater undergoes a treatment process to remove the dissolved salts, metals, and other contaminants so that the recovered, clean water can be reused in future fracking operations or various other purposes such as, for example, agricultural irrigation. Various treatment processes are used to treat such wastewater. These include membrane filtration (like reverse osmosis), chemical precipitation, advanced oxidation processes, and distillation.

A typical distillation process involves heating the wastewater, which separates the water from the dissolved salts, metals, and other contaminants. The water vapor is then condensed to produce clean water for reuse. One particular distillation system that has been proposed is to use the exhaust gas from a gas turbine engine to heat the wastewater within a tank. However, if the level of the wastewater is not maintained with sufficient accuracy, it can cause excessive pressure within the tank and reduce heat transfer between the wastewater and exhaust gas.

Hence, there is a need for a distillation system uses exhaust gas from a gas turbine engine to treat wastewater in a tank and that maintains water level in the tank at a level that does not cause excessive pressure within the tank and/or does not reduce heat transfer between the wastewater and exhaust gas. The present disclosure addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a distillation system fluid level control system includes a tank, a diffuser, a fluid pump, a fluid level sensor, and a level control. The tank has a first end wall, a second end wall, a front wall, a back wall, a top wall, and a bottom wall that together define an inner volume. A divider wall is disposed within the tank and divides the inner volume into a main chamber and a settling chamber. The main chamber has at least a fluid inlet port and an exhaust gas inlet port, and the settling chamber has at least an exhaust gas outlet port. The divider wall has at least one opening formed therein that provides fluid communication between the main chamber and the settling chamber. The diffuser is disposed within the main chamber and is coupled to the exhaust gas inlet port. The diffuser is adapted to receive exhaust gas discharged from a gas turbine engine. The fluid pump is in fluid communication with the fluid inlet port, and is configured, in response to pump commands, to supply fluid from a fluid source to the fluid inlet port. The fluid level sensor is coupled to the tank and is configured to sense fluid level within the settling chamber and supply a fluid level sensor signal representative thereof. The level control is in operable communication with the fluid level sensor and the pump. The level control is coupled to receive the fluid level sensor signal from the fluid level sensor and is configured to supply the pump commands to the fluid pump based at least in part on the fluid level sensor signal, to thereby control the fluid level within the inner volume.

In another embodiment, a distillation system fluid level control system includes a tank, a diffuser, an exhaust duct, a fluid pump, a fluid level sensor, and a level control. The tank has a first end wall, a second end wall, a front wall, a back wall, a top wall, and a bottom wall that together define an inner volume. A divider wall is disposed within the tank and divides the inner volume into a main chamber and a settling chamber. The main chamber has at least a fluid inlet port and an exhaust gas inlet port, and the settling chamber has at least an exhaust gas outlet port. The divider wall has at least one opening formed therein that provides fluid communication between the main chamber and the settling chamber. The diffuser is disposed within the main chamber and is coupled to the exhaust gas inlet port. The diffuser is adapted to receive exhaust gas discharged from a gas turbine engine. The exhaust duct is coupled between the gas turbine engine and the exhaust gas inlet port and is configured to direct the exhaust gas discharged from the gas turbine engine into the exhaust gas inlet port. The fluid pump is in fluid communication with the fluid inlet port, and is configured, in response to pump commands, to supply fluid from a fluid source to the fluid inlet port. The fluid level sensor is coupled to the tank and is configured to sense fluid level within the settling chamber and supply a fluid level sensor signal representative thereof. The level control is in operable communication with the fluid level sensor and the pump. The level control is coupled to receive the fluid level sensor signal from the fluid level sensor and is configured to supply the pump commands to the fluid pump based at least in part on the fluid level sensor signal, to thereby control the fluid level within the inner volume.

Furthermore, other desirable features and characteristics of the distillation system with fluid level control system will become apparent from the subsequent detailed description and the appended claims, taken in conjunction with the accompanying drawings and the preceding background.

### BRIEF DESCRIPTION OF DRAWINGS

The present disclosure will hereinafter be described in conjunction with the following drawing figure, wherein like numerals denote like elements, and wherein:

FIG. 1 depicts a simplified functional schematic diagram of one embodiment of a distillation system with fluid level control system.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

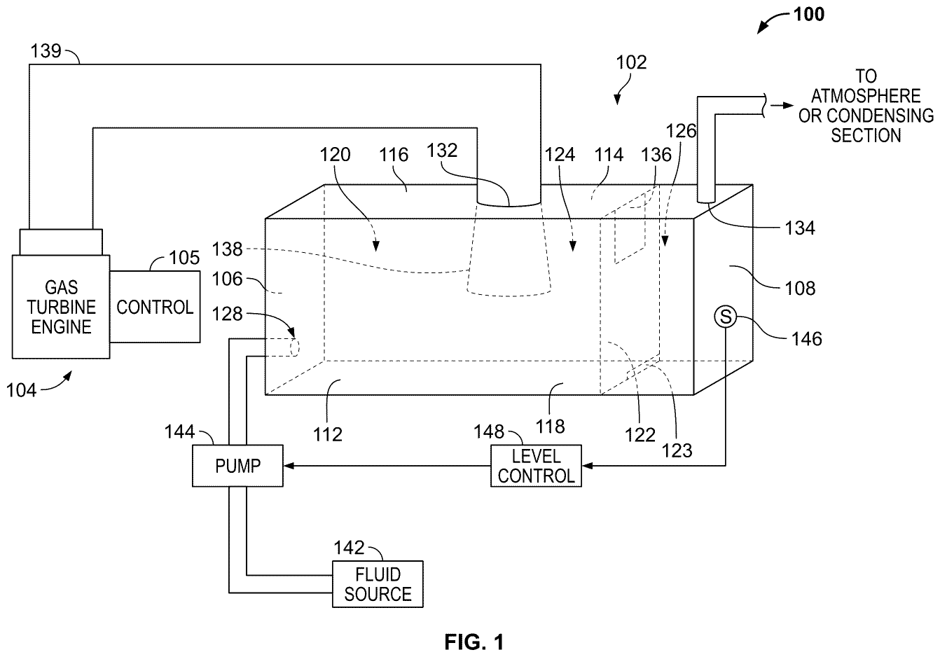

Referring now to FIG. 1, a simplified functional schematic diagram of one embodiment of a distillation system 100 is depicted and includes a tank 102 and a gas turbine engine 104. The tank 102 has a first end wall 106, a second end wall 108, a front wall 112, a back wall 114, a top wall 116, and a bottom wall 118. Together, the walls 106-116 define an inner volume 120.

As FIG. 1 also depicts, a divider wall 122 is disposed within the tank 102 and divides the inner volume 120 into a main chamber 124 and a settling chamber 126. The main chamber 124 has at least a fluid inlet port 128 and an exhaust gas inlet port 132, and the settling chamber 126 at least an exhaust gas outlet port 134. The divider wall 122 has a divider wall opening 136 formed therein that provides fluid communication between the main chamber 124 and the settling chamber 126. It should be noted that the exhaust gas outlet port 134 may be variously sized to meet desired performance characteristics. Preferably, however, it has a relatively large diameter to reduce the velocity of the gas being discharged and to reduce any entrained mist within the gas. In one embodiment, the exhaust gas outlet port 134 has a 36-inch diameter.

The gas turbine engine 104 is in fluid communication with the exhaust gas inlet port 132. During operation of the gas turbine engine 104, the gas turbine engine 104 discharges exhaust gas into the main chamber 124. And more specifically, the gas turbine engine 104 discharges exhaust gas into the main chamber 124 via a diffuser 138 that is disposed within the main chamber 124 and is coupled to the exhaust gas inlet port 132. In some embodiments, such as the one depicted in FIG. 1, an exhaust duct 139 is coupled between the gas turbine engine 104 and the exhaust gas inlet port 132. The exhaust duct 139, when included, is configured to direct the exhaust gas discharged from the gas turbine engine 104 into the exhaust gas inlet port 132.

Before proceeding further, it is noted that the distillation system 100, at least in the depicted embodiment, additionally includes an engine control 105 that is in operable communication with the gas turbine engine 104. The engine control 105 is configured to control the operation of the gas turbine engine 104. It will be appreciated that the gas turbine engine 104 may be implemented using any one of numerous types of gas turbine engines 104. In one particular embodiment, however, the gas turbine engine 104 is implemented using an auxiliary power unit (APU), such as an APU that is typically configured for use in commercial aircraft. It will additionally be appreciated that the engine control 105 may be implemented using any one of numerous known engine controls.

No matter how the gas turbine engine 104 and engine control 105 are specifically implemented, it will be appreciated that the diffuser 138 functions to slow the flow of the exhaust gas discharged by the gas turbine engine 104. The diffuser 138 additionally functions to promote exhaust flow distribution along the length of the main chamber 124 to better interact with the fluid (not shown in FIG. 1), such as wastewater, that is supplied to the inner volume 120 of the tank 102. It will be appreciated that the sides of the diffuser 138 may be disposed at any one of numerous angles relative to exhaust gas inlet port 132. In one particular embodiment, the sides are angled at about 5-degrees. However, this angle may vary as needed to meet desired performance characteristics.

In addition to the diffuser 138, additional structural features are included within the inner volume 120 of the tank 102 to further improve the distillation process implemented by the distillation system 100. A description of the additional structural features is not needed to enable the claimed invention. Thus, these additional structural features are not depicted in FIG. 1 and a description thereof will not be provided.

As FIG. 1 further depicts, at least one fluid opening 123 extends through the divider wall 122 and is located adjacent to the bottom wall 118 of the tank 102. The fluid opening 123 provides fluid communication between the settling chamber 126 and the main chamber 124 to allow any fluid that condenses within the settling chamber 126 to flow into the main chamber 124.

It should be noted that during operation of the distillation system 100, fluid within the inner volume 120 is maintained at or above a predetermined fluid level. The predetermined fluid level is based on the evaporation rate within the tank 102 and for optimal operability of the gas turbine engine 104. Although various techniques could be used to maintain the fluid within the inner volume at or above the predetermined fluid level, in the depicted embodiment, the distillation system 100 additionally includes a fluid source 142, a fluid pump 144, a fluid level sensor 146, and a level control 148.

The fluid source 142, which may be variously configured, is the source of the fluid that is to be distilled by the distillation system 100. The fluid pump 144 is disposed between, and is in fluid communication with, the fluid source 142 and the main chamber 124. The fluid pump 144, which may be implemented using any one of numerous known fluid pumps, is configured to maintain the fluid within the inner volume 120 at or above the predetermined fluid level.

The fluid level sensor 146 is disposed on or within the tank 102. More specifically, the fluid level sensor 146 is preferably disposed on or within the settling chamber 126 since, during operation, this is the most quiescent location within in the tank inner volume 120. The fluid level sensor 146 is configured to sense the fluid level within the settling chamber 126 and supply a fluid level signal indicative of the sensed fluid level. It will be appreciated that the fluid level sensor 146 may be implemented using any one of numerous types of fluid level sensors. Some non-limiting examples of suitable types of fluid level sensors include optical sensors, ultrasonic sensors, guide pulse sensors, and radar sensors, just to name a few.

The level control 148 is in operable communication with the fluid level sensor 146 and the pump 144. The level control 148 is coupled to receive the fluid level sensor signal from the fluid level sensor 146 and is configured to supply the pump commands to the fluid pump 144 based at least in part on the fluid level sensor signal, to thereby control the fluid level within the inner volume 120. Although the level control 148 and engine control 105 are depicted in FIG. 1 using separate functional blocks, it will be appreciated that the level control 148 and the engine control 105 may be integrally formed and/or may be disposed within a common housing.

The distillation system disclosed herein uses exhaust gas from a gas turbine engine to treat wastewater in a tank and maintains water level in the tank at a level that does not cause excessive pressure within the tank and/or does not reduce heat transfer between the wastewater and exhaust gas.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A distillation system fluid level control system, comprising:
a tank having a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having at least one opening formed therein that provides fluid communication between the main chamber and the settling chamber;
a diffuser disposed within the main chamber and coupled to the exhaust gas inlet port, the diffuser adapted to receive exhaust gas discharged from a gas turbine engine;
a fluid pump in fluid communication with the fluid inlet port, the fluid pump configured, in response to pump commands, to supply fluid from a fluid source to the fluid inlet port;
a fluid level sensor coupled to the tank, the fluid level sensor configured to sense fluid level within the settling chamber and supply a fluid level sensor signal representative thereof; and
a level control in operable communication with the fluid level sensor and the pump, the level control coupled to receive the fluid level sensor signal from the fluid level sensor and configured to supply the pump commands to the fluid pump based at least in part on the fluid level sensor signal, to thereby control the fluid level within the inner volume.

2. The distillation system of claim 1, further comprising:
a fluid source having fluid stored therein, the fluid source in fluid communication with the fluid pump.

3. The distillation system of claim 1, further comprising:
an engine control in operable communication with the gas turbine engine, and configured to control the operation of the gas turbine engine.

4. The distillation system of claim 3, wherein the level control and the engine control are integrally formed.

5. The distillation system of claim 3, wherein the level control and the engine control are disposed within a common housing.

6. The distillation system of claim 1, wherein the fluid level sensor comprises an optical sensor.

7. The distillation system of claim 1, wherein the fluid level sensor comprises an ultrasonic sensor.

8. The distillation system of claim 1, wherein the fluid level sensor comprises a guide pulse sensor.

9. The distillation system of claim 1, wherein the fluid level sensor comprises a radar sensor.

10. The distillation system of claim 1, further comprising:
an exhaust duct coupled between the gas turbine engine and the exhaust gas inlet port, the exhaust duct configured to direct the exhaust gas discharged from the gas turbine engine into the exhaust gas inlet port.

11. A distillation system fluid level control system, comprising:
a tank having a first end wall, a second end wall, a front wall, a back wall, a top wall, and a bottom wall that together define an inner volume, a divider wall disposed within the tank and dividing the inner volume into a main chamber and a settling chamber, the main chamber having at least a fluid inlet port and an exhaust gas inlet port, the settling chamber having at least an exhaust gas outlet port, the divider wall having at least one opening formed therein that provides fluid communication between the main chamber and the settling chamber;
a diffuser disposed within the main chamber and coupled to the exhaust gas inlet port, the diffuser adapted to receive exhaust gas discharged from a gas turbine engine;
an exhaust duct coupled between the gas turbine engine and the exhaust gas inlet port, the exhaust duct configured to direct the exhaust gas discharged from the gas turbine engine into the exhaust gas inlet port;
a fluid level sensor coupled to the tank, the fluid level sensor configured to sense fluid level within the settling chamber and supply a fluid level sensor signal representative thereof; and
a level control in operable communication with the fluid level sensor, the level control coupled to receive the fluid level sensor signal from the fluid level sensor and configured to supply pump commands to a fluid pump based at least in part on the fluid level sensor signal, to thereby control the fluid level within the inner volume.

12. The distillation system of claim 11, further comprising:
a fluid pump in fluid communication with the fluid inlet port, the fluid pump configured, in response to pump commands, to supply fluid from a fluid source to the fluid inlet port.

13. The distillation system of claim 12, further comprising:
a fluid source having fluid stored therein, the fluid source in fluid communication with the fluid pump.

14. The distillation system of claim 11, further comprising:
an engine control in operable communication with the gas turbine engine, and configured to control the operation of the gas turbine engine.

15. The distillation system of claim 14, wherein the level control and the engine control are integrally formed.

16. The distillation system of claim 14, wherein the level control and the engine control are disposed within a common housing.

17. The distillation system of claim 11, wherein the fluid level sensor comprises an optical sensor.

18. The distillation system of claim 11, wherein the fluid level sensor comprises an ultrasonic sensor.

19. The distillation system of claim 11, wherein the fluid level sensor comprises a guide pulse sensor.

20. The distillation system of claim 11, wherein the fluid level sensor comprises a guide pulse sensor.
